(19) United States
(12) Patent Application Publication
(10) Pub. No.: US 2010/0208216 A1
(43) Pub. Date: Aug. 19, 2010

(54) PROJECTOR AND CONTROL METHOD

(75) Inventor: Naofumi Hirabayashi, Suwa-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/703,282

(22) Filed: Feb. 10, 2010

(30) Foreign Application Priority Data
Feb. 16, 2009 (JP) 2009-032537

(51) Int. Cl. G03B 21/20

(52) U.S. Cl. 353/85

(57) ABSTRACT

[Problem] There is provided a projector and the like capable of appropriately preventing image light from being projected without an intention in the state in which the image light of the projector can be projected in accordance with an operation of a remote controller.

[Means for Resolution] A projector 100 is configured including a light receiving section 110 disposed on a projection side of the image light and a light receiving section 111 disposed on a non-projection side of the image light, in order for receiving input of image light projection instruction information from a remote controller 200, a determination section 130 for performing determination of whether or not the image light projection instruction information input to the light receiving section 110 is valid based on setting data 122, and a control section 150 for performing the control based on the image light projection instruction information input to the light receiving sections 110, 111 if the result of the determination is true, or performing the control based on the image light projection instruction information input to the light receiving section 111 if the result of the determination is false.

### TECHNICAL FIELD

The present invention relates to a projector and a control method of the projector.

### BACKGROUND ART

In the case of using a projector while placing the projector on the floor, there is a possibility that an infant or the like mistakenly presses the power switch of the projector to switch on the projector, looks into the projection lens, and is damaged in the eyes. Although there is provided a projector, which is not powered on unless the power switch is pressed for a predetermined period of time in the case in which a so-called child safety lock setting is put on in order for coping with this circumstance, there still remains a possibility that the infant press the power switch for the predetermined period of time, and therefore, this method fails to appropriately achieve eye protection.

Further, there is also proposed a projector having a configuration of disposing the projection lens so as to be able to move forward and backward with respect to a cabinet of the projector, making it possible to extend the projection lens to the projection position from the inside of the cabinet when in use and to retract the projection lens inside the cabinet when not in use, thereby switching on/off the power switch of the projector in conjunction with the forward and backward movement of the projection lens.

However, in the case of this method, there arises a problem that the power is easily switched on if the user forgets to return the projection lens to the specified position after the projection has terminated. Further, although there is proposed a method of automatically switching the image to be a dedicated image when no input signal is provided to the projector, this method also has a possibility that the user looking into the lens is damaged in the eyes. Further, although a method of using an openable lens cover is also possible, there arises a problem that an infant or the like easily turns on the power switch in the case in which the user forgets to close the lens cover after cool-down after use of the projector has been terminated.

As a method of solving the problems described above, in JP-A-2008-116628 there is proposed a projector performing control of preventing the power from being switched on in the case in which a power on operation is performed without performing a predetermined operation in the projector main body.

### [Related Art Document]

### [Patent Document]

[Patent Document 1] JP-A-2008-116628

### SUMMARY OF THE INVENTION

### Problem that the Invention is to Solve

However, in reality, power on and off of the projector is performed not only by an operation on the main body, but also by an operation on a remote controller, and therefore, if it is controlled so that the power switch is prevented from being switched on unless the projector main body is operated, usability for the user is problematically degraded.

An object of the invention is to provide a projector and a control method of a projector capable of appropriately preventing image light from being projected without an intention in the state in which the image light of the projector can be projected in accordance with an operation of a remote controller.

### Means for Solving the Problem

In order for solving the problem described above, a projector according to the invention includes an image projection section adapted to project an image based on an image signal input, a plurality of control signal receiving sections adapted to receive input of a projection control signal adapted to set the image projection section to be in a state in which the image projection section is capable of projecting the image, and a setting section adapted to set an operation mode of the projector, wherein if the operation mode is set to be a safe mode for restricting projection of the image by the image projection section, the image projection section is controlled based on the projection control signal input from a predetermined control signal receiving section.

According to the invention, since the projector controls the image projection section based on the projection control signal input from a predetermined control signal receiving section, it is possible for the image light caused by an unintended operation to restrict the projection.

Further, according to the projector of another application example of the invention, it is also possible that the control signal receiving sections include a first information input section and a second information input section adapted to receive the projection control signal from a remote controller, the second information input section is disposed at a location where a range in which the second information input section can receive the projection control signal and a range through which light projected from the image projection section passes have no overlap, and if the operation mode is set to be the safe mode, the image projection section is controlled based on the projection control signal input from the second information input section. According to this configuration, since the image is prevented from being projected due to projection control signal indication information input from the side from which the image light is projected if the operation mode of the projector is set to be the safe mode, even if an infant or the like emits an image projection control signal from the projection side of the image light using a remote controller, it is possible to prevent the eyes from being damaged by the intense light projected from the image projection section. In essence, projection of the image light due to an unintended operation of the remote controller can be restricted.

Further, according to the projector of another application example of the invention, it is also possible that the image projection section includes a light source, and a light source control section adapted to control lighting and extinction of the light source, and the light source control section is controlled based on the projection control signal. According to this configuration, since the light source constituting the image projection section is prevented from lighting due to an unintended operation if the operation mode of the projector is set to be the safe mode, an extremely safe projector can be provided.

Further, according to the projector of another application example of the invention, it is also possible that the image projection section includes a projection lens, and a lens cover adapted to protect the projection lens, and opening and closing of the lens cover is controlled based on the projection control signal. According to this configuration, since the lens cover constituting the image projection section is prevented from opening due to an unintended operation if the operation mode of the projector is set to be the safe mode, an extremely safe projector can be provided.

Further, according to the projector of another application example of the invention, it is also possible that a notification section adapted to give notice that the operation mode is set to be the safe mode when the projection control signal is received through the control signal receiving section other than the predetermined control signal receiving section in a condition in which the operation mode is set to be the safe mode. According to this configuration, the user of the projector can quickly figure out the fact that the operation mode is set to be the safe mode in the case in which the projector does not project the image despite the input of the lighting control signal, which is highly convenient.

Further, according to the projector of another application example of the invention, it is also possible that a reading device adapted to read information recorded on a removable recording medium is further provided, and the projection control signal includes a signal adapted to control at least either one of an operation of reading information from the recording medium and an operation of ejecting the recording medium. According to this configuration, since the operation of making the reading device provided to the projector read the content of the recording medium on which the image information or the like is recorded is in conjunction with the projection control signal, image projection can be started by, for example, instructing the play-back of the recording medium loaded in the reading device, which is highly convenient. Further, since play-back of the recording medium and projection of the image due to an unintended operation are prevented, an extremely safe projector can be provided.

It should be noted that the invention is not limited to the application examples described above, but can take various forms such as a control method of a projector, a program for making a computer execute the control method, or a computer readable information storage medium storing the program.

### BRIEF DESCRIPTION OF THE DRAWINGS

FIG. 1 is a diagram showing a use condition of a projector in a first embodiment.

FIG. 2 is a functional block diagram of the projector in the first embodiment.

FIG. 3 is a flowchart showing a light source driving procedure in the first embodiment.

FIG. 4 is a diagram showing a use condition of a projector in a second embodiment.

FIG. 5 is a functional block diagram of the projector according to the second embodiment.

FIG. 6 is a flowchart showing a light source driving procedure in the second embodiment.

FIG. 7 is a functional block diagram of a projector in a modified example.

### MODE FOR CARRYING OUT THE INVENTION

Hereinafter, some embodiments of the invention applied to a projector will be described with reference to the accompanying drawings. It should be noted that the embodiments described below do not at all limit contents of the invention as set forth in the appended claims. Further, not necessarily all of the constituents shown in the embodiments below are indispensable as the means for solving the problem in the invention set forth in the appended claims.

### First Embodiment

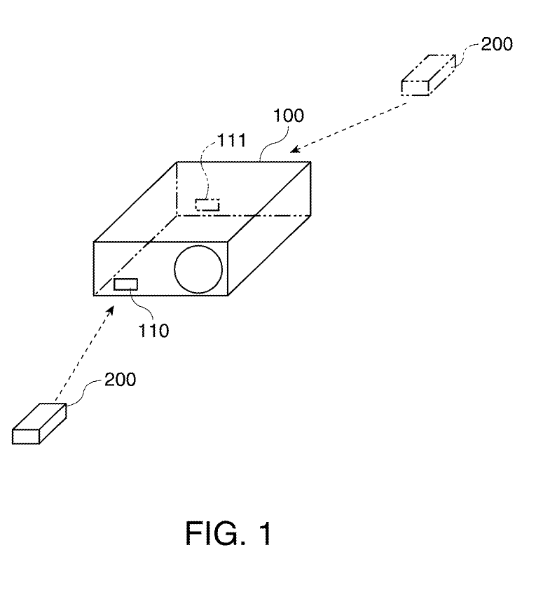

FIG. 1 is a diagram showing a use condition of a projector 100 in a first embodiment. The projector 100 has a light receiving section 110 disposed in a direction along which an image projection section of the invention projects an image, namely on the front side of a housing as a projection side of the image light, and a light receiving section 111 disposed on the rear side of the housing as a non-projection side of the image light. It should be noted that the light receiving section 110 functions as a first information input section for inputting image light projection instruction information from a remote controller 200 on the projection side, and the light receiving section 111 functions as a second information input section for inputting the image light projection instruction information on the non-projection side. It should be noted that the image light projection instruction information corresponds to an image projection control signal of the invention.

In the case, for example, in which the image light is projected in response to a mistaken operation of a power button or the like of the remote controller 200 by an infant or the like located on the projection side of the image light, there is a possibility that the image light damages the eyes. In the present embodiment, there is performed the control of not driving power supply or the like even in the case in which holding-down operation information of the power button or the like of the remote controller 200 is received in the light receiving section 110 in accordance with setting of the operation mode.

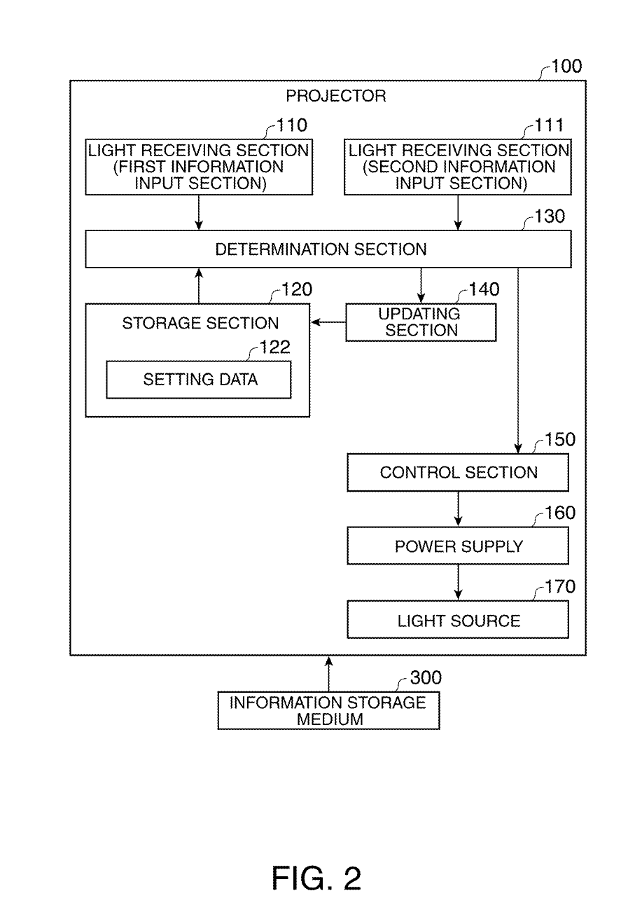

Then, the functional block of the projector 100 having such functions will be explained. FIG. 2 is a functional block diagram of the projector 100 in the first embodiment.

The projector 100 is configured including the light receiving sections 110, 111, a storage section 120 for storing setting data 122 representing whether or not the image light projection instruction information input to the light receiving section 110 is valid, a determination section 130 for performing determination of whether the image light projection instruction information input to the light receiving section 110 is valid based on the setting data 122, an updating section 140 for performing update of the setting data 122 and so on, a power supply 160, a light source 170, and a control section 150 for performing, for example, power control for switching on the power supply 160. The control section 150 has a function as a light source control section for controlling putting on and off of the light source 170, and driving of the light source 170 while lighting. It should be noted that the light source 170 constitutes the image projection section of the invention together with a light modulation device for modulating light, which is input from the light source 170, in accordance with an image signal, the projection lens, and so on (any not shown). The constituents of the image projection section are not limited to those described above.

It should be noted that in the projector 100 the function of each of these sections can be implemented using the following hardware. For example, in the projector 100 it is also possible that the light receiving sections 110, 111 are implemented using infrared communication units or the like, the storage section 120 is implemented using a nonvolatile memory or the like, the determination section 130, the updating section 140, and the control section 150 are implemented using a so-called computer such as a CPU, the power supply 160 is implemented using a power supply unit or the like, and the light source 170 is implemented using a lamp or the like.

Further, it is also possible for the projector 100 to control the function of the determination section 130 or the like by executing a program previously stored in an information storage medium 300. As such an information storage medium 300, CD-ROM, DVD-ROM, ROM, RAM, HDD, and so on can be applied.

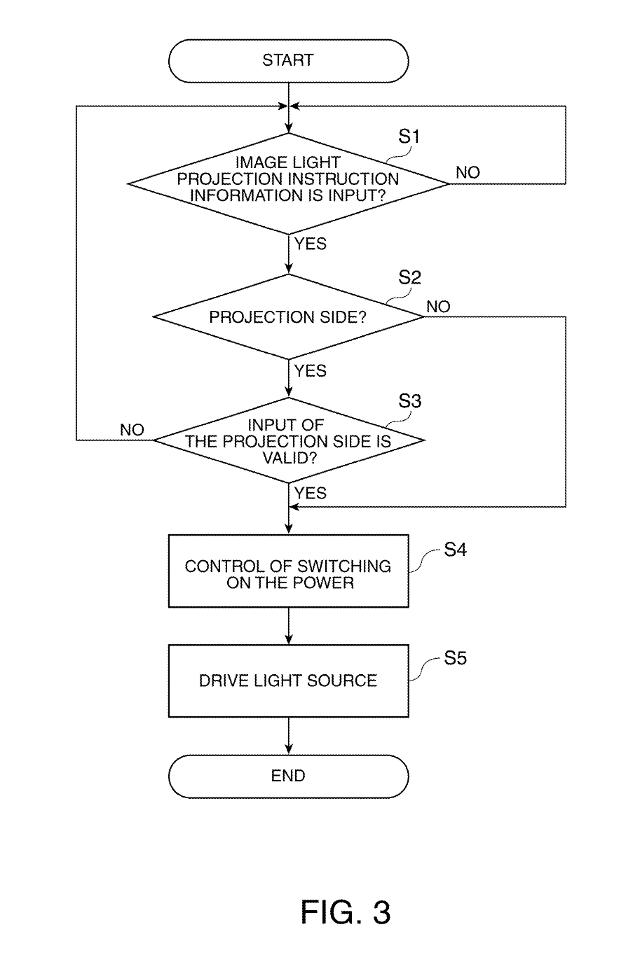

Then, a light source driving procedure using these sections will be explained. FIG. 3 is a flowchart showing the light source driving procedure in the first embodiment.

When validating a safe mode, a so-called child safety lock function, of the invention, the user displays a configuration menu image using the projector 100, and operating the operation panel provided to the main body of the projector 100 or the remote controller 200 to thereby perform setting for validating the child safely lock in the configuration menu.

The updating section 140 updates the setting data 122 in accordance with these operations. For example, in the case in which the setting operation for validating the child safely lock is performed, if the image light projection instruction information input to the light receiving section 110 is invalid, and the setting operation for invalidating the child safety lock has been performed, the updating section 140 updates the setting data 122 so as to represent that the image light projection instruction information input to the light receiving section 110 is valid. According to the procedure described above, the child safely lock function is set accordingly. It should be noted that although in the present embodiment a configuration of disposing the light receiving section 110 on the front panel of the projector 100, and the light receiving section 111 on the rear panel of the projector 100 is described as an example, the invention is not limited thereto, but a configuration of disposing the light receiving section 110 on an edge portion formed between the front panel and the top panel, and a configuration of disposing the light receiving section 110 on an edge portion formed between the front panel and a side panel are possible. Further, a configuration of disposing the light receiving section 111 on the edge portion formed between the rear panel and the top panel, and a configuration of disposing the light receiving section 111 on the edge portion formed between the rear panel and a side panel are possible. In essence, it is sufficient to dispose the light receiving section 111 at a location where the light receiving section 111 fails to receive the image light projection instruction information transmitted from a space in the range through which the light projected from the image projection section passes, namely the space of the range determined in accordance with the maximum field angle of the projector 100. Therefore, if only the condition described above is satisfied, the light receiving section 111 can also be disposed on a side panel of the projector 100. In other words, it is sufficient to design the mounting location of the light receiving section 111 with respect to the projector 100 so that the range in which the light receiving section 111 can receive the image light projection instruction information and the range through which the light projected from the image projection section passes do not overlap with each other.

The user pushes the power button of the remote controller 200 in the state in which the power supply 160 of the projector 100 is switched off, thereby outputting the image light projection instruction information to the projector 100. It should be noted that in the present embodiment, the image light projection instruction information is information representing the instruction to switch on the power supply 160.

The determination section 130 determines whether or not the light receiving section 110 or the light receiving section 111 input the image light projection instruction information (step S1), and at the same time, determines whether or not it is input by the light receiving section 110 on the projection side (step S2).

If the image light projection instruction information is input by the light receiving section 110 on the projection side, the determination section 130 determines whether or not the image light projection instruction information input to the light receiving section 110 is valid referring to the setting data 122 (step S3).

If the image light projection instruction information is input to the light receiving section 110, and the image light projection instruction information input to the light receiving section 110 is valid, or if the image light projection instruction information is input to the light receiving section 111, the control section 150 performs control for switching on the power supply 160 (step S4).

If the power supply 160 is switched on, the light source 170 is also driven (step S5), and the projector 100 projects the image light.

On the other hand, if the image light projection instruction information is input to the light receiving section 110 and the image light projection instruction information input to the light receiving section 110 is invalid, the power supply 160 is not switched on, the light source 170 is not driven, and the image light is not projected.

As described hereinabove, according to the present embodiment, the projector 100 performs the control using the image light projection instruction information input to the non-projection side of the image light if the image light projection instruction information input to the projection side of the image light, thereby making it possible to prevent the projection of the image light even if the image light projection instruction information is input from the projection side of the image light by an infant or the like. Thus, the projector 100 can appropriately prevent the image light from being projected without intention in the condition in which the image light of the projector 100 can be projected in accordance with the remote control operation.

Further, according to the present embodiment, since the user can update the setting data 122 in accordance with the use condition of the user, by setting the image light projection instruction information to the projection side of the image light to be valid in the condition in which in an infant or the like is not present, while setting the image light projection instruction information to the projection side of the image light to be invalid in the condition in which an infant or the like is present, for example, it is possible to selectively use the child safely lock function and the image light projection side input function in accordance with the condition.

### Second Embodiment

The projector can be of an integrated type together with a disk play-back section for playing back a disk such as a DVD. Further, although nothing is performed in the first embodiment in the case in which the input of the image light projection instruction information to the projection side is invalid, it is also possible to give notice of the fact that the input of the image light projection instruction information is invalid using, for example, a sound or light.

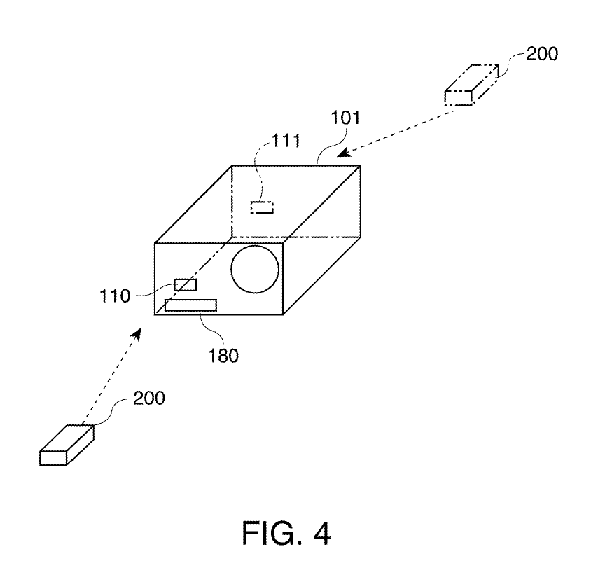

FIG. 4 is a diagram showing a use condition of the projector 100 in a second embodiment. The projector 101 has a disk play-back section 180, and performs light source control for driving the light source 170 in response to either one of a disk eject instruction to the disk play-back section 180 and a play-back instruction to the disk play-back section 180. Here, the disk play-back section 180 corresponds to a reading device in the invention, and has a function of retrieving information recorded on various types of optical disks as removable recording media.

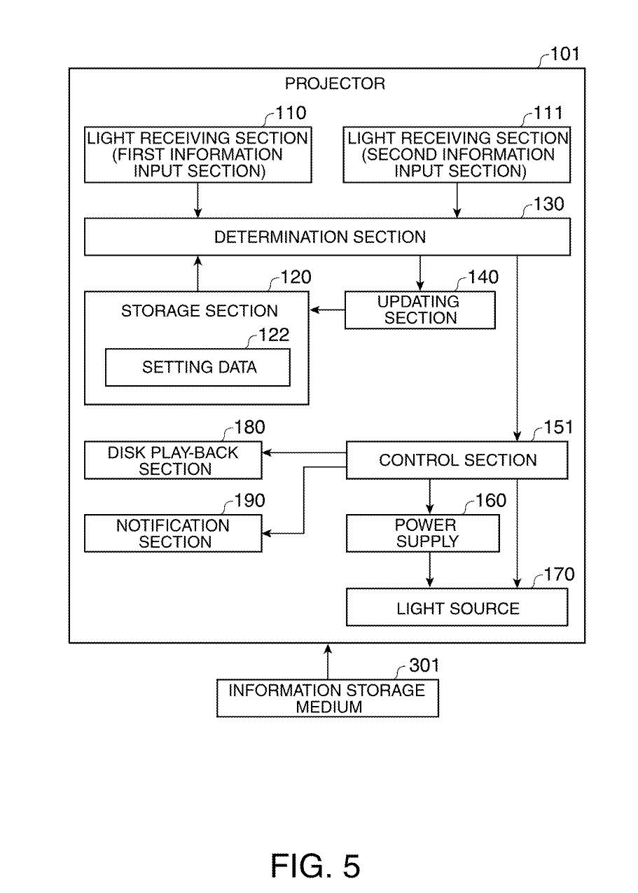

Then, the functional block of the projector 101 having such a function will be explained. FIG. 5 is a functional block diagram of the projector 101 in the second embodiment. The projector 101 has a configuration substantially the same as that of the projector 100 of the first embodiment, but different from the configuration of the projector 100 in that the disk play-back section 180 and a notification section 190 are provided, and that the control section 151 controls the disk play-back section 180 and the notification section 190 in addition to the power supply 160 and the light source 170.

Specifically, the disk play-back section 180 corresponds to a DVD play-back unit, a Blu-ray disc play-back unit, or the like, and the notification section 190 corresponds to an LED or the like. It should be noted that the projector 101 can be configured to control these constituents by executing a program previously stored in the information storage medium 301.

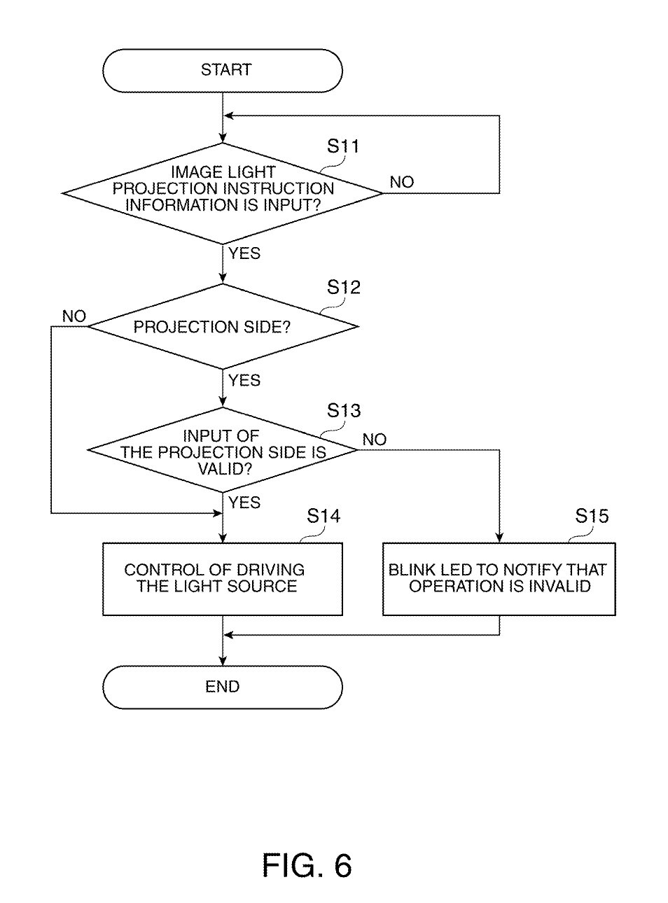

Then, a light source driving procedure using these sections will be explained. FIG. 6 is a flowchart showing the light source driving procedure in the second embodiment.

The user presses the power button of the remote controller 200, a disk eject button (e.g., an eject button) of the remote controller 200, or a play-back button of the remote controller 200, thereby outputting the image light projection instruction information to the projector 100. It should be noted that in the present embodiment, the image light projection instruction information is information representing the disk eject instruction or the play-back instruction of a disk.

The determination section 130 determines whether or not the light receiving section 110 or the light receiving section 111 input the image light projection instruction information (step S11), and at the same time, determines whether or not it is input by the light receiving section 110 on the projection side (step S12).

If the image light projection instruction information is input by the light receiving section 110 on the projection side, the determination section 130 determines whether or not the image light projection instruction information input to the light receiving section 110 is valid referring to the setting data 122 (step S13).

If the image light projection instruction information is input to the light receiving section 110, and the image light projection instruction information input to the light receiving section 110 is valid, or if the image light projection instruction information is input to the light receiving section 111, the control section 151 performs control for driving the light source 170 (step S14). It should be noted that in this case the control section 151 performs eject control of the disk or play-back control of the disk on the disk play-back section 180 in accordance with the content of the instruction.

On the other hand, if the image light projection instruction information is input to the light receiving section 110, and the image light projection instruction information input to the light receiving section 110 is invalid, the control section 151 blinks the LED of the notification section 190 to thereby notify the user of the fact that the operation is invalid. In this case, the light source 170 is not driven, and the image light is not projected.

As described above, according to the present embodiment, the projector 101 can exert substantially the same function and advantage as in the first embodiment. Further, according to the present embodiment, the projector 101 can perform the projection control of the image light appropriately in accordance with various instructions regarding the projection of the image light.

Further, according to the present embodiment, the projector 101 can notify the user of the fact that the operation is invalid. Thus, the user can easily understand the cause of the condition in which the disk is not played back even by pressing the disk play-back button.

### Other Embodiments

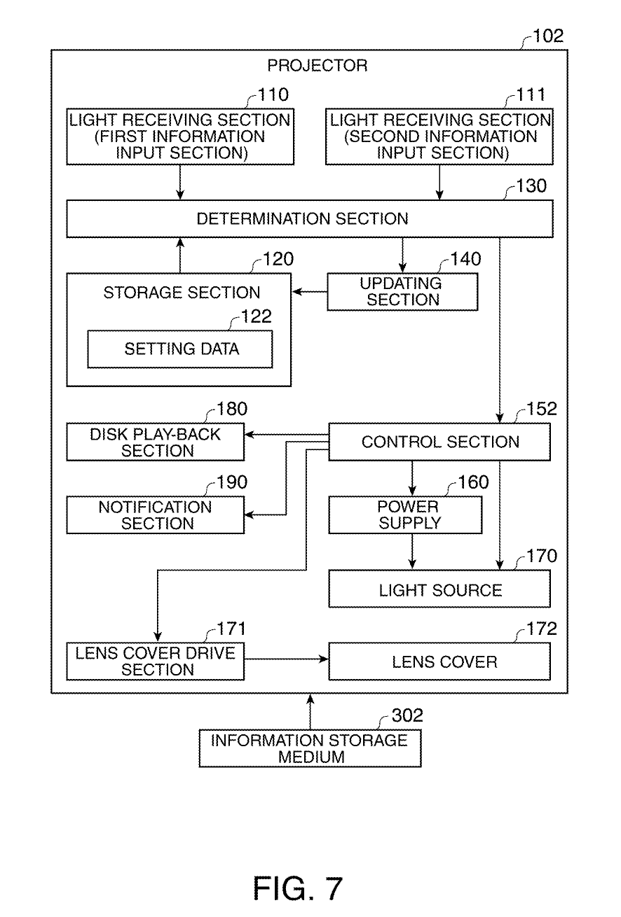

It should be noted that applications of the present invention is not limited to the embodiments described above, but various modifications thereof are possible. FIG. 7 is a block diagram of a projector 102 capable of opening and closing control of a lens cover for the projection lens in accordance with the button operation of the remote controller 200. It is also possible for the control section 152 to perform opening and closing of the lens cover 172 by controlling a lens cover drive section 171 in accordance with the setting data 122 in the condition in which, for example, the image light is projected but the projected light is not projected outside the projector 102 due to the cover of the projection lens being closed.

Specifically, it is also possible for the control section 152 to perform the control of keeping the state in which the lens cover 172 is kept closed in the case in which the image light projection instruction information is input to the light receiving section 110 and the image light projection instruction information input to the light receiving section 110 is invalid, and of opening the lens cover 172 in the case in which the image light projection instruction information is input to the light receiving section 110 and the image light projection instruction information input to the light receiving section 110 is valid, or the image light projection instruction information is input to the light receiving section 111. The control described above can be performed by the CPU not shown executing a program previously recorded on the information storage medium 302.

Further, the method of the notification by the notification section 190 is not limited to the method of blinking the LED, but can be a method of giving a notice using a method of putting on the LED, a method of performing image display on a liquid crystal screen of the projector or the remote controller, a method of outputting a sound in the projector or the remote controller, or a method combining these methods.

Further, the locations of the light receiving sections 110, 111 are not limited to the front panel and the rear panel, but can be, for example, the top panel, the side panels, and so on providing the instruction location can be specified. Further, the number of light receiving sections 110, 111 is not limited to two, but can be three or more. For example, it is also possible to dispose two light receiving sections on each of the front panel and the rear panel. Further, the first and second information input sections are not limited to the light receiving sections 110, 111, but can be receiving sections for wirelessly receiving the information, for example. Further, the communication medium between the remote controller and the information input section is not limited to electromagnetic waves, but sound waves with high directionality in an inaudible frequency band can also be used. For example, a configuration of demodulating the image light projection instruction information, which has been modulated into an ultrasonic wave by the remote controller, into an electrical signal using a microphone provided to the projector is possible. In this case, the microphone described above corresponds to the information input section of the invention.

Further, in the embodiments described above, if the setting for invalidating the image light projection instruction information input to the light receiving section 110 is performed, it is also possible to perform control for preventing the light receiving section 110 from receiving the light by performing, for example, control of stopping the power supply to the light receiving section 110, or control of closing the external cover of the light receiving section 110. Further, it is also possible to dispose a switch between the light receiving section 110 and the determination section, and break the switch to thereby block the signal from the light receiving section 110. In essence, it is sufficient to prevent a valid signal from being output from the light receiving section 110.

Further, although in the embodiments described above the disk play-back section 180 is described as an example of the reading device of the invention, the invention is not limited thereto. Specifically, it is obvious that as a removable recording medium, a nonvolatile semiconductor memory can be adopted in addition to various types of optical disks. As such a semiconductor memory, various flash memory devices can be used, and it is possible to adopt an adapter corresponding to the semiconductor memory described above to the projectors 100, 101, 102 as the reading device of the invention.

Further, it is possible for the projectors 100, 101, 102 to have the light modulation device included in the image projection section configured using various types of liquid crystal panels (a transmissive type or a reflective type such as LCOS) or Digital Micromirror Device (DMD). It should be noted that DMD™ is a trademark owned by Texas Instruments (United States). Further, the function of the projectors 100, 101, 102 can be implemented in two or more devices (e.g., a PC and a projector) in a distributed manner.

It should be noted that the light source of each of the projectors 100, 101, 102 is not limited to a specific type, but various types such as a discharge lamp, organic EL, a light emitting diode, and a semiconductor laser are possible.

Further, although in the embodiments described above it is assumed that the remote controller 200 transmits the image light projection instruction information to the light receiving sections 110, 111, it is preferable that the remote controller 200 is configured so as to be able to transmit a control signal including the image light projection instruction information and for controlling the whole or a part of the function each of the projectors 100 through 102 has.

Further, although in the embodiments described above the child safety lock function is described as an example of the safe mode of the invention, this does not limit the invention. The mode in which the projector does not project the image light when the image light projection instruction information is transmitted from a space in a range through which the light projected from the image projection section of the projector passes is included in the safe mode of the invention regardless of the name of the function and the operation mode.

### DESCRIPTION OF REFERENCE NUMERALS AND SIGNS

100, 101, 102: projector
110: light receiving section (first information input section)
111: light receiving section (second information input section)
120: storage section
122: setting data
130: determination section
140: updating section 150, 151, 152: control section
160: power supply
170: light source
171: projection lens
172: lens cover
180: disk play-back section
190: notification section
200: remote controller
300, 301, 302: information storage medium

1. A projector comprising:
an image projection section adapted to project an image based on an image signal input;
a plurality of control signal receiving sections adapted to receive input of a projection control signal adapted to set the image projection section to be in a state in which the image projection section is capable of projecting the image; and
a setting section adapted to set an operation mode of the projector,
wherein if the operation mode is set to be a safe mode for restricting projection of the image by the image projection section, the image projection section is controlled based on the projection control signal input from a predetermined control signal receiving section.

2. The projector according to claim 1, wherein
the control signal receiving sections include a first information input section and a second information input section adapted to receive the projection control signal from a remote controller,
the second information input section is disposed at a location where a range in which the second information input section can receive the projection control signal and a range through which light projected from the image projection section passes have no overlap, and
if the operation mode is set to be the safe mode, the image projection section is controlled based on the projection control signal input from the second information input section.

3. The projector according to claim 1, wherein
the image projection section includes
a light source, and
a light source control section adapted to control lighting and extinction of the light source, and
the light source control section is controlled based on the projection control signal.

4. The projector according to claim 1, wherein
the image projection section includes
a projection lens, and
a lens cover adapted to protect the projection lens, and
opening and closing of the lens cover is controlled based on the projection control signal.

5. The projector according to claim 1, further comprising:
a notification section adapted to give notice that the operation mode is set to be the safe mode when the projection control signal is received through the control signal receiving section other than the predetermined control signal receiving section in a condition in which the operation mode is set to be the safe mode.

6. The projector according to claim 1, further comprising:
a reading device adapted to read information recorded on a removable recording medium,
wherein the projection control signal includes a signal adapted to control at least either one of an operation of reading of information from the recording medium and an operation of ejecting the recording medium.

7. A control method of a projector including an image projection section and a plurality of control signal receiving sections, the method comprising:
setting an operation mode of the projector;
receiving input of a projection control signal adapted to set the image projection section to be in a state in which the image projection section is capable of projecting the image using the control signal receiving sections; and
controlling the image projection section based on the projection control signal input from a predetermined control signal receiving section if the operation mode is set to be a safe mode for restricting projection of the image by the image projection section.

8. The control method according to claim 7, further comprising:
configuring the control signal receiving sections so as to include a first information input section and a second information input section adapted to receive the projection control signal from a remote controller;
disposing the second information input section at a location where a range in which the second information input section can receive the projection control signal and a range through which light projected from the image projection section passes have no overlap; and
controlling the image projection section based on the projection control signal input from the second information input section if the operation mode is set to be the safe mode.

9. The control method according to claim 7, further comprising:
configuring the image projection section so as to include a light source and a light source control section adapted to control lighting and extinction of the light source; and
controlling the light source control section based on the projection control signal.

10. The control method according to claim 7, further comprising:
configuring the image projection section so as to include a projection lens, and a lens cover adapted to protect the projection lens; and
controlling opening and closing the lens cover based on the projection control signal.

11. The control method according to claim 7, further comprising:
notifying that the operation mode is set to be the safe mode when the projection control signal is received through the control signal receiving section other than the predetermined control signal receiving section in a condition in which the operation mode is set to be the safe mode.

12. The control method according to claim 7, further comprising:
providing a reading device of a recording medium; and
receiving a signal adapted to control at least either one of an operation of reading information from the removable recording medium and an operation of ejecting the recording medium using the control signal receiving section.
